(19) United States
(12) Patent Application Publication
(10) Pub. No.: US 2013/0320625 A1
(43) Pub. Date: Dec. 5, 2013

(54) INSERTION APPARATUS

(71) Applicant: JONATHAN ISCH, BLUFFTON, IN (US)

(72) Inventor: JONATHAN ISCH, BLUFFTON, IN (US)

(73) Assignee: MICROMATIC LLC, BERNE, IN (US)

(21) Appl. No.: 13/483,804

(22) Filed: May 30, 2012

(51) Int. Cl. F02F 5/00; B05C 5/02; B65D 83/76

(52) U.S. Cl. 277/310; 222/251; 118/320

(57) ABSTRACT

An insertion apparatus supplies malleable material into a piston ring groove. An arcuate nozzle is supplied with malleable material under pressure created by a plunger urged by an actuator driven by an electric motor. A rotatable piston nest made of resilient material receives and snuggly secures a piston therein. The rotatable piston nest and piston are movable between a first, retracted position and a second, extended position. In the extended position the groove of the piston ring is spaced in proximity to the arcuate nozzle where malleable material is metered into the groove. Rotational indexing of the piston enables placement of the malleable material in circumferential locations within the piston ring groove.

### FIELD OF THE INVENTION

The field of the invention is in the assembly of piston rings within piston ring grooves.

### BACKGROUND OF THE INVENTION

United States Patent Publication Publication No.: US 201110290106 A1, states in the Abstract thereof, as follows: “A piston assembly includes an annular body defining a groove, with a ring disposed within the groove. The piston assembly includes a centering device disposed within the groove between an inner face of the ring and a root of the groove. The centering device centers the ring concentrically within the groove when the ring is in an uncompressed condition, prior to installation into a bore of an engine block, to prevent the inner face of the ring from moving radially outward beyond an outer edge of the groove when the ring is in the uncompressed condition.”

### SUMMARY OF THE INVENTION

A malleable material insertion apparatus in combination with an automobile piston having a piston ring groove includes a tube containing malleable material therein. A plunger resides within the tube and engages the malleable material therein. The plunger is movable within the tube and is driven by an actuator. An electric motor drives the actuator which, in turn, drives and moves the plunger within the tube. A nozzle is affixed to the nozzle mounting block which includes a passageway therethrough for communicating the malleable material. The malleable material is preferably a wax. The nozzle mounting block includes a shoulder therein which engages the end of the tube. Sometimes herein the tube is referred to as a cartridge.

The electric motor is a high speed electric motor. Specifically, the electric motor is a servo motor that is tuned to rotate at the appropriate speed to dispense the proper amount of wax. The motor drives the actuator which includes a planetary gear reducer. The planetary gear reducer produces 0.1 inch of travel per revolution. The planetary gear reducer is an in-line planetary gear reducer.

The nozzle includes an arcuate opening and a passageway therein. The tube, the passageway in the nozzle mounting block, and the passageway in the nozzle are filled with malleable material therein. A rotatable piston nest is made of a resilient material such as a nylon plastic typically filled with molybdenum disulfide lubricant powder. Other plastics may be used for the piston nest. Alternatively, the rotatable piston nest may be made of a soft metal. The piston resides in the resilient rotatable piston nest and is gripped by the resilient piston nest such that the piston is rotatable with the rotatable piston nest. A piston nest housing supports the rotatable piston nest such that the rotatable piston nest is rotatable within the piston nest housing.

The piston nest housing, the rotatable piston nest and the piston are movable and slidable on a rail. The piston nest housing, the rotatable piston nest, and the piston nest are movable between a first, retracted position and a second, extended position. When the piston nest housing, the rotatable piston nest, and the piston are in the first, retracted position, the piston is spaced remotely apart from the nozzle. When the piston nest housing, the piston nest, and the piston are in the second, extended position, the piston is spaced in proximity with the nozzle. The piston is spaced approximately 1.5 mm within the piston ring groove when the piston nest housing, the piston nest, and the piston are in the second, extended position.

The electric motor drives the actuator moving the plunger within the tube applying pressure to the malleable material in the tube, in the passageway in the nozzle mounting block, in the passageway in the nozzle, and in the arcuate opening depositing the malleable material in the piston ring groove. The malleable material adheres to the root or bottom of the piston ring groove.

A control system meters wax or other suitable malleable material from the arcuate opening based on a current sensor which measures electric current supplied to the electric motor. Means for discontinuing electric current to the electric motor, for example a switch, a relay, or an electronic switching device, are used to discontinue power to the electric motor when the electric current supplied to the motor reaches a predetermined value. When the current reaches a predetermined level, the actuator has moved the plunger within the tube far enough to push approximately 70 mg of wax out of the nozzle and deposit it in the piston ring groove. A clamp is affixed to the rotatable piston housing for moving the rotatable piston housing, the piston nest and the piston between the first, retracted position and the second, extended position and then back to the first, retracted position. In the second, extended position, the clamp locks and maintains the piston in position for receiving the wax deposit. A clamp not having the locking feature may be used.

A piston nest spacer is secured to the piston nest housing by using a first and second bolt. First and second bolts are threaded into the piston nest housing and reside in a spool formed at the bottom of the piston nest spacer. The spool enables the piston nest spacer to rotate. A bearing is interposed between the piston nest housing and the piston nest spacer allowing the piston nest spacer to rotate with respect to the piston nest housing. The rotatable piston nest is affixed to the rotatable piston nest spacer.

A rail includes a first stationary track and a second track slidably engaged with the track. The piston nest housing is affixed to the second track of the rail and slides therewith. The first stationary track is affixed to a support plate. The mounting plate supports the clamp, the first stationary track, the second track, the piston nest housing, the piston nest spacer, and the piston nest.

The rotatable piston nest is affixed to the rotatable piston nest spacer. The piston nest spacer includes a cylindrical periphery. The cylindrical periphery of the piston nest spacer includes a plurality of notches for controlling the position at which the wax is inserted into the piston ring groove. The piston nest housing includes a spring biased plunger affixed thereto which engages one of the plurality of the notches of the cylindrical periphery of the piston nest spacer. The spring biased plunger engages successive ones of the plurality of the notches of the cylindrical periphery of the piston nest spacer as the piston nest spacer and piston are rotated. The piston nest spacer is rotated by hand and has an octagonal flange which is easily gripped by the operator of the insertion apparatus. The piston is releasably affixed to the piston nest spacer and rotates therewith.

A process for inserting a malleable material into a piston ring groove of a piston, comprising the steps of: loading a piston having a piston ring groove into a resilient rotatable piston nest snugly fitting said piston in said piston nest, said resilient rotatable piston nest affixed to a rotatable piston spacer, said rotatable piston spacer includes a first notch, a second notch, a third notch and a fourth notch; rotating said rotatable piston nest, said rotatable piston nest spacer and said snugly fit piston until said first notch of said rotatable piston nest spacer engages an indexing mechanism; moving said piston nest and said piston toward a nozzle placing said nozzle within said piston ring groove of said piston; restraining and clamping said resilient rotatable piston nest and said piston against movement away from said nozzle; injecting a malleable material into a first location in said piston ring groove of said piston; rotating said rotatable piston nest, said rotatable piston spacer and said snugly fit piston until said second notch of said rotatable piston spacer engages said indexing mechanism; injecting a malleable material into a second location in said piston ring groove of said piston; rotating said rotatable piston nest, said rotatable piston spacer and said snugly fit piston until said third notch of said rotatable piston spacer engages said indexing mechanism; injecting a malleable material into a third location in said piston ring groove of said piston; rotating said rotatable piston nest, said rotatable piston spacer and said snugly fit piston until said fourth notch of said rotatable piston spacer engages said indexing mechanism; injecting a malleable material into a fourth location in said piston ring groove of said piston; retracting and unclamping said piston nest and said piston away from said nozzle; and, removing said piston from said piston nest.

The step of injecting a malleable material in the piston ring groove of the piston includes metering the malleable material injected into the groove. The step of injecting the malleable material in the piston ring groove of the piston includes metering the wax and inserting 70 mg of wax in the piston ring groove. The wax is injected into the piston ring groove for a period of time as determined by motor current. The deposition of the wax is discontinued and then the piston is rotated and the deposition process is initiated by the operator depressing a button which starts the electric motor.

Another embodiment of the process does not depend on a specific number of notches in the rotatable piston nest spacer. The process for inserting a malleable material into a piston ring groove of a piston, includes the steps of: loading a piston having a piston ring groove into a resilient rotatable piston nest snugly fitting said piston in said piston nest, said resilient rotatable piston nest affixed to a rotatable piston spacer, said rotatable piston spacer includes a plurality of notches; rotating said rotatable piston nest, said rotatable piston nest spacer and said snugly fit piston until said first notch of said rotatable piston nest spacer engages an indexing mechanism; moving said piston nest and said piston toward a nozzle placing said nozzle within said piston ring groove of said piston; restraining and clamping said resilient rotatable piston nest and said piston against movement away from said nozzle; injecting a malleable material into a first location in said piston ring groove of said piston; and, repeating said step of rotating said rotatable piston nest, said rotatable piston nest spacer and said snugly fit piston until all successive notches have been reached and interengaged by said indexing mechanism and said malleable material has been deposited in all locations in said piston ring groove of said piston. The preferred malleable material into is wax.

It is an object of the invention to provide an electric motor, an actuator driven by the electric motor, which produces linear movement of a shaft which, in turn, drives a plunger in a wax-filled tube expelling the wax into and through a nozzle.

It is a further object of the invention to provide a high speed electric motor wherein, specifically, the electric motor is a servo motor.

It is a further object of the invention to provide a servo motor having an output speed capable of approximately 3000 rpm.

It is a further object of the invention to provide a servo motor that is tuned to rotate at the appropriate speed to dispense the proper amount of wax.

It is a further object of the invention to provide an actuator which includes an in-line planetary gear reducer which produces 0.1 inch of linear travel per revolution. Other rates of linear travel are also contemplated.

It is a further object of the invention to provide a malleable material insertion apparatus which reliably and dependably dispenses a desired amount of malleable material into a piston ring groove at desired locations.

It is a further object of the invention to provide a malleable material insertion apparatus which inserts the desired amount of wax into the desired locations of the piston ring groove of a piston.

It is a further object of the invention to insert wax into the piston ring groove of a piston in a reliable and efficient manner so as to enable the positioning of a piston ring within the groove such that the piston ring is stable and properly positioned for further processing and/or assembly in an engine.

It is a further object of the invention to provide a piston nest which releasably secures the piston therein.

These and other objects will be best understood when reference is made to the drawing figures, the description of the invention and the claims which follow hereinbelow.

### BRIEF DESCRIPTION OF THE DRAWINGS

FIG. 1 is a perspective view of the malleable material insertion apparatus and control system.

FIG. 2 is a perspective view of the malleable material insertion apparatus.

FIG. 2A is an enlarged perspective view of the clamp mechanism, piston nest, piston indexing mechanism, malleable material nozzle, nozzle block, malleable material tube, plunger and shaft.

FIG. 2B is an enlarged perspective view of the actuator, electric motor and shaft.

FIG. 3 is a top view of the malleable material holder, malleable material tube, nozzle block and nozzle.

FIG. 3A is a cross-sectional view of the nozzle, nozzle block and the tube taken along the lines 3A-3A of FIG. 3.

FIG. 3B is a front perspective view of the nozzle.

FIG. 3C is rear perspective view of the nozzle.

FIG. 3D is a front view of the nozzle.

FIG. 3E is an enlarged portion of FIG. 3D.

FIG. 3F is a cross-sectional view of the nozzle taken along the lines 3F-3F of FIG. 3D.

FIG. 3G is an enlargement of a portion of FIG. 3F illustrating the nozzle.

FIG. 3H is a cross-sectional view of the nozzle taken along the lines 3H-3H of FIG. 3D.

FIG. 4 is a top view of the piston nest assembly, straight line clamp and a portion of the rail.

FIG. 4A is a cross-sectional view taken along the lines 4A-4A of FIG. 4 illustrating the piston nest assembly and rail assembly.

FIG. 4B is a cross-sectional view taken along the lines 4B-4B of FIG. 4 illustrating the piston nest assembly, rail assembly, and piston nest indexing mechanism.

FIG. 4C is an enlargement of a portion of FIG. 4B illustrating the piston nest indexing mechanism.

FIG. 4D is a side view of the piston nest assembly, rail assembly and clamp.

FIG. 4E is a cross-sectional view taken along the lines 4E-4E of FIG. 4D illustrating the piston nest indexing mechanism, the piston nest spacer, and the notches in the periphery of the piston nest spacer.

FIG. 4F is an enlargement of a portion of FIG. 4E illustrating the indexing mechanism engaging one of the notches in the periphery of the piston nest spacer.

FIG. 5 is a top view of the piston nest assembly with a piston gripped and secured within the piston nest spaced apart from the malleable material insertion nozzle in the first, retracted position.

FIG. 5A is a side view of FIG. 5.

FIG. 5B is a top view of the piston nest assembly with a piston gripped and secured within the piston nest spaced in proximity to the malleable material insertion nozzle in the second, extended position.

FIG. 5C is a side view of FIG. 5B.

FIG. 5D is a cross-sectional view taken along the lines 5D-5D of FIG. 5B.

FIG. 5E is an enlarged portion of FIG. 5D illustrating the nozzle inserted in one of the piston ring grooves of the piston.

FIG. 5F is an enlarged portion of FIG. 5E illustrating the nozzle.

FIG. 5G is an enlargement similar to FIG. 5F illustrating the malleable material being distributed into the piston ring groove of the piston.

FIG. 5H is an enlargement similar to FIG. 5G with the malleable material in the piston ring groove of a piston.

FIG. 5I is a view looking radially inwardly into the piston ring groove of the piston illustrating the arcuate deposition of the malleable material into the piston ring groove.

### DESCRIPTION OF THE INVENTION

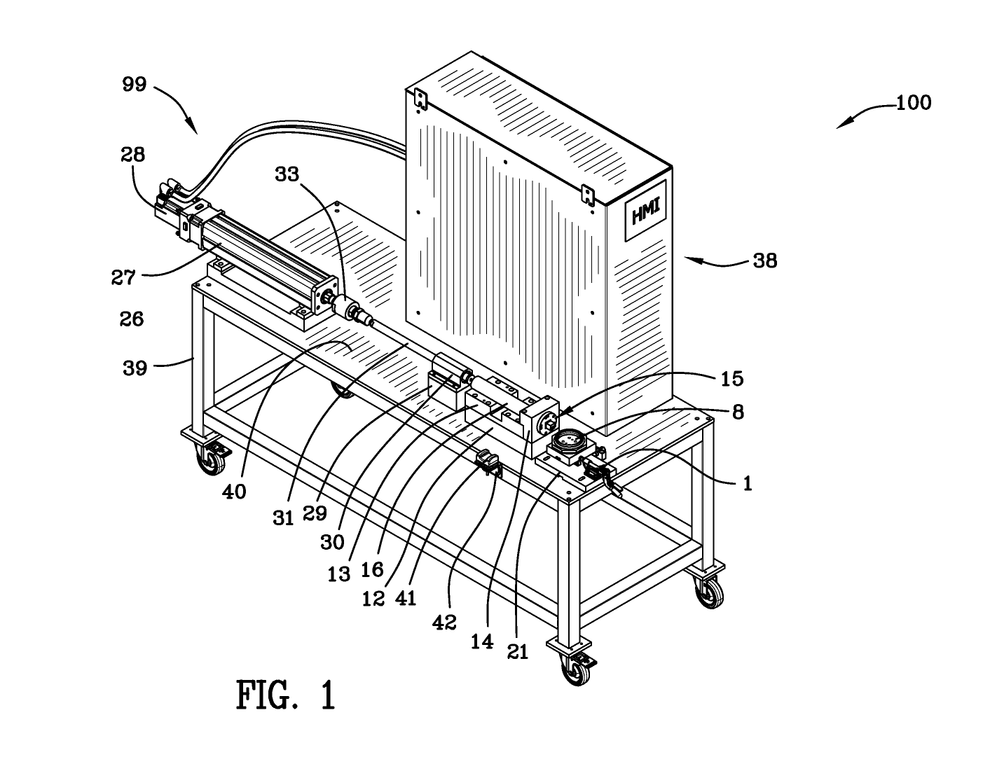

FIG. 1 is a perspective view 100 of the malleable material insertion apparatus 99 and control system 38. FIG. 1 illustrates high speed electric motor 28 and actuator 27. Specifically, the electric motor is a servo motor that is tuned to rotate at the appropriate speed to dispense the proper amount of wax. The actuator 27 includes an in-line planetary gear reducer which produces 0.1 inch of linear travel per revolution. Other linear travel rates are specifically contemplated. Control system 38, among other things, measures current supplied to motor 28 and discontinues supply of the electric current to the electric motor, for example by using a switch, a relay, or an electronic switching device, to discontinue power to the electric motor when the electric current supplied to the motor reaches a predetermined value. A sensor, not shown, determines and measures current supplied to motor 28. When the current reaches a predetermined level, the actuator has moved the plunger within the tube far enough to push approximately 70 mg of wax out of the nozzle depositing it in the piston ring groove. Insertion of the malleable material is initiated by depressing push button 41 in mounting 42 which starts motor 28. Each time the piston is rotated 90°, malleable material, preferably wax, is inserted in the piston ring groove of the piston. Other deposition profiles may be used such that wax may be deposited at a plurality of “n” locations where “n” is greater than or equal to 2.

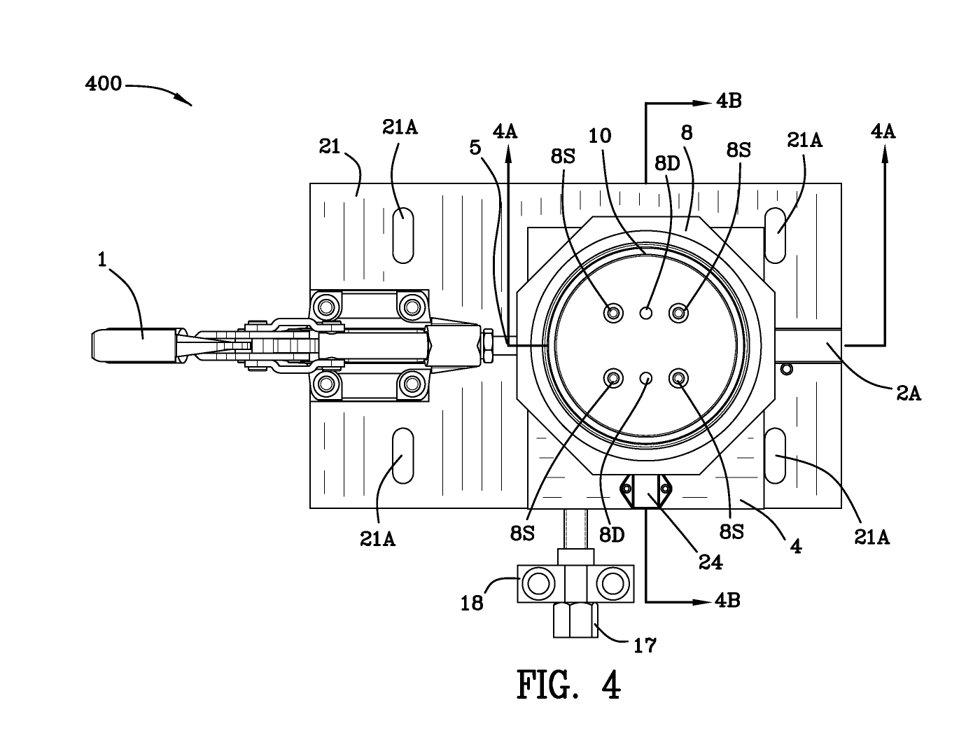

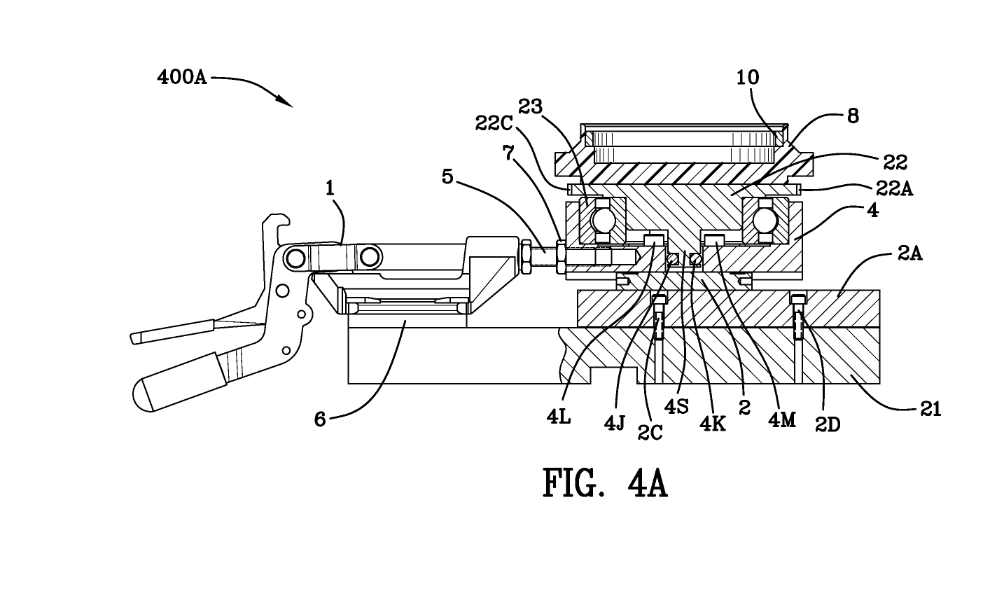

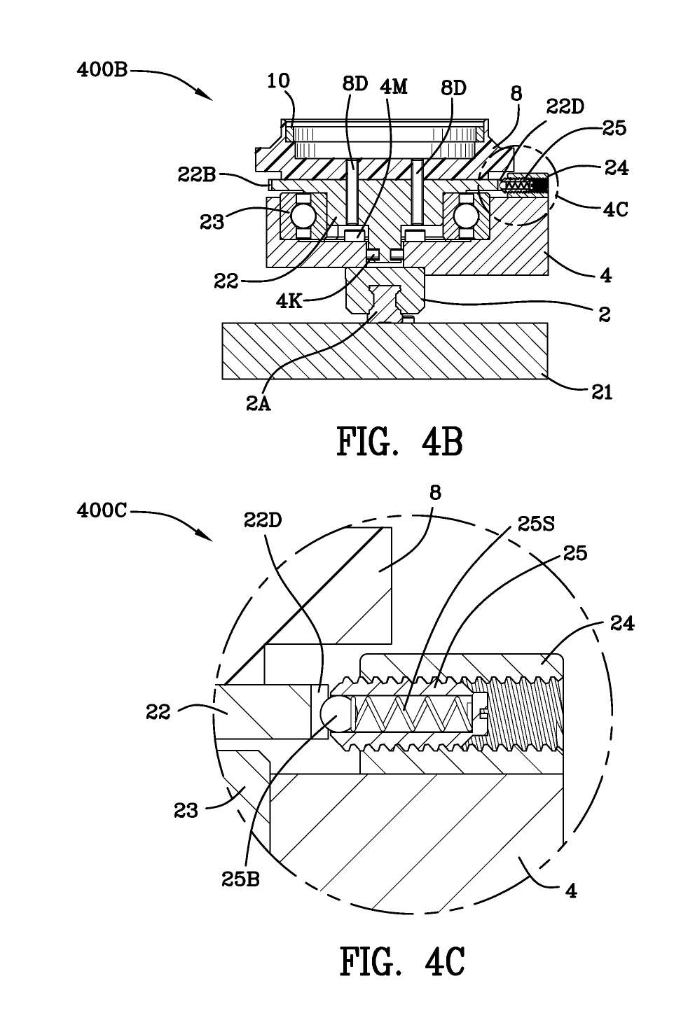

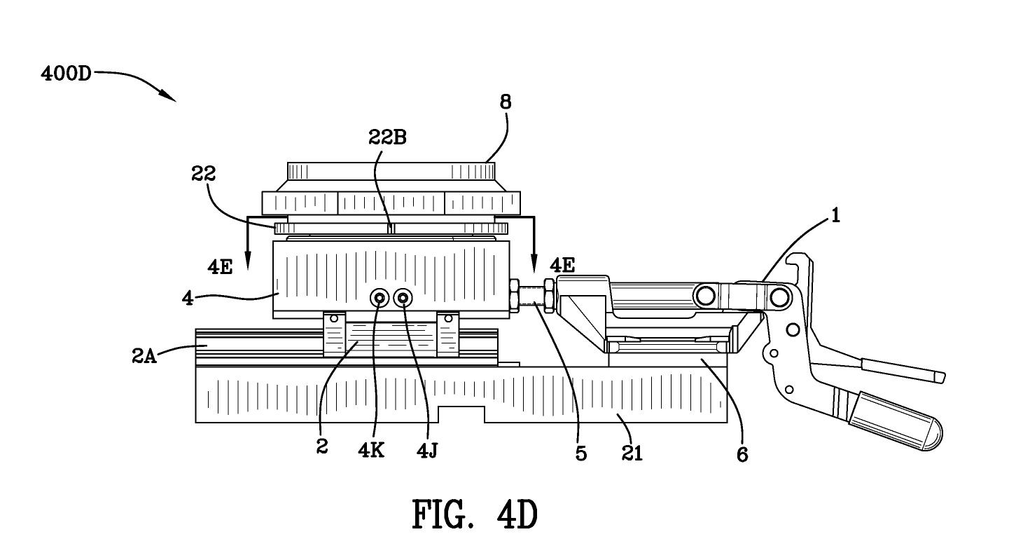

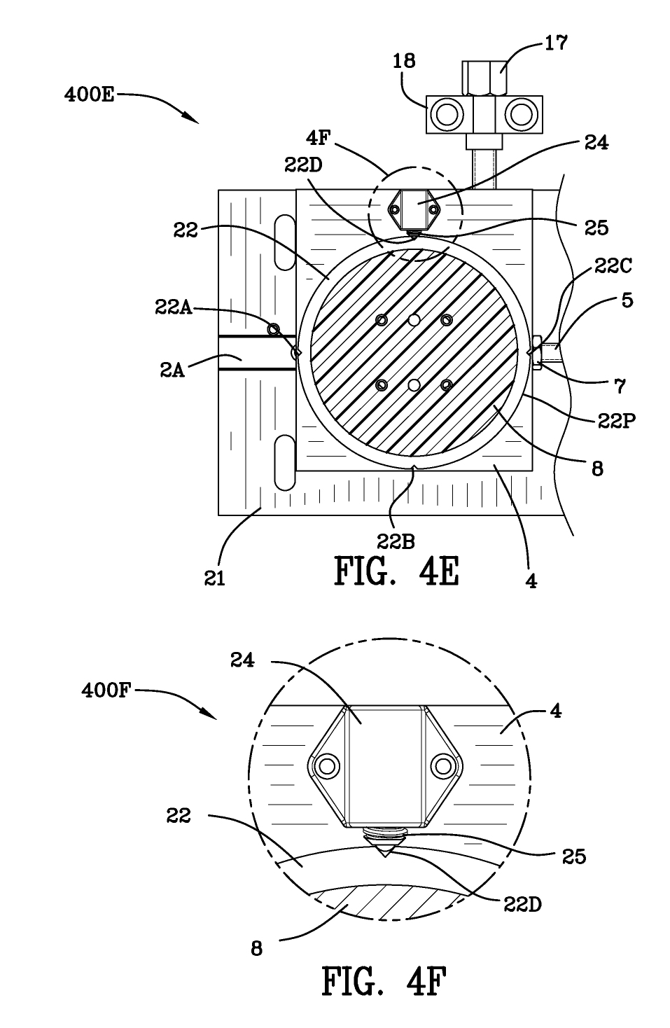

Still referring to FIG. 1, reference numeral 30 indicates a bearing for support of the shaft 31 and the plunger 32. Various bolt holes and bolts for connecting various elements of the invention are illustrated in the drawings. In a few instance the bolts or screws are not illustrated for the purpose of drawing clarity. It is understood by those skilled in the art that various connectors and connections may be used in these various holes. For instance, referring to FIG. 4, slots 21A in the support plate for the clamp 1, rail 2, 2A, and piston nest housing 4, are not illustrated with bolts or screws but those skilled in the art readily recognize that bolts and screws of all types may be used to affix the various elements and components together.

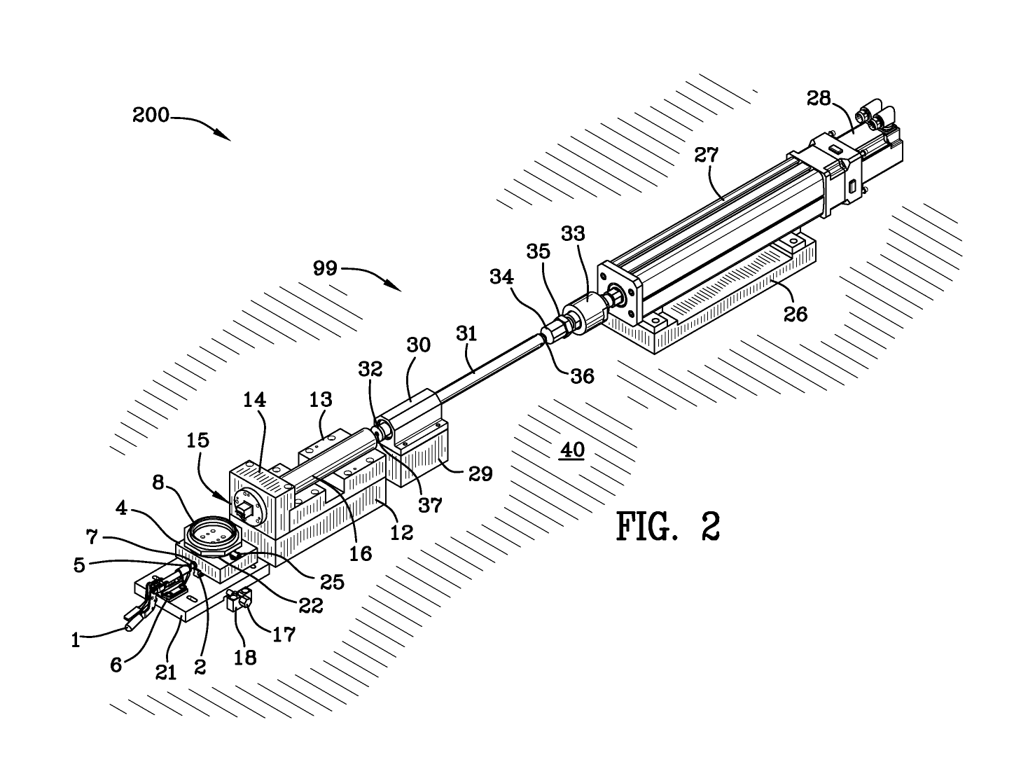

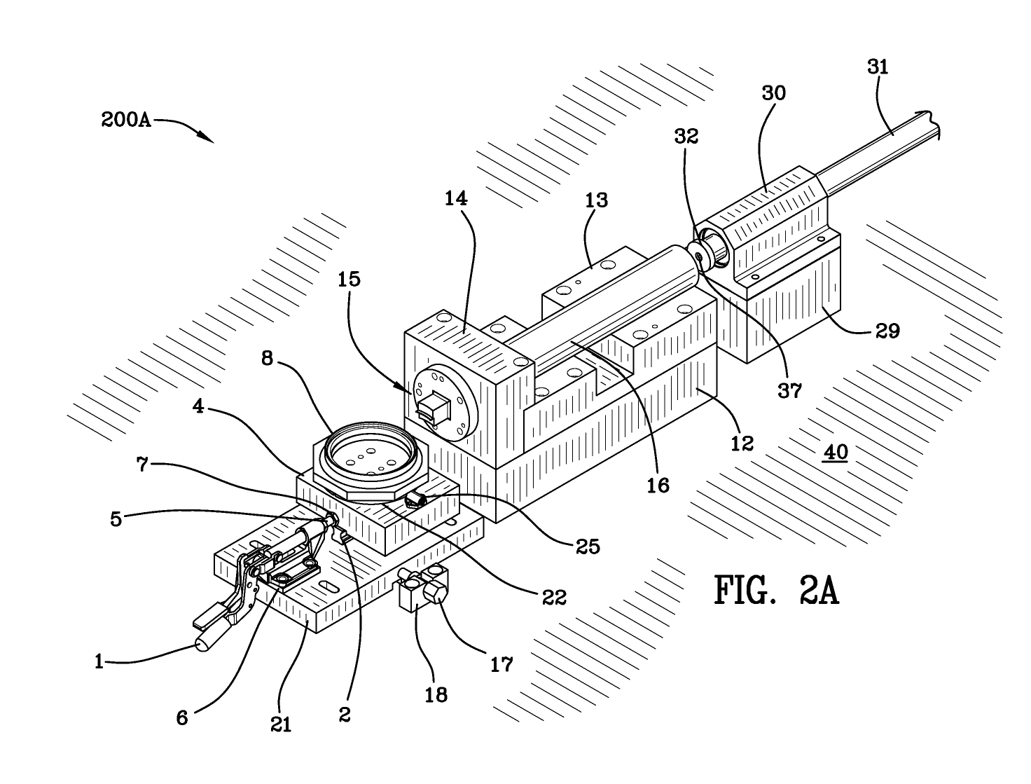

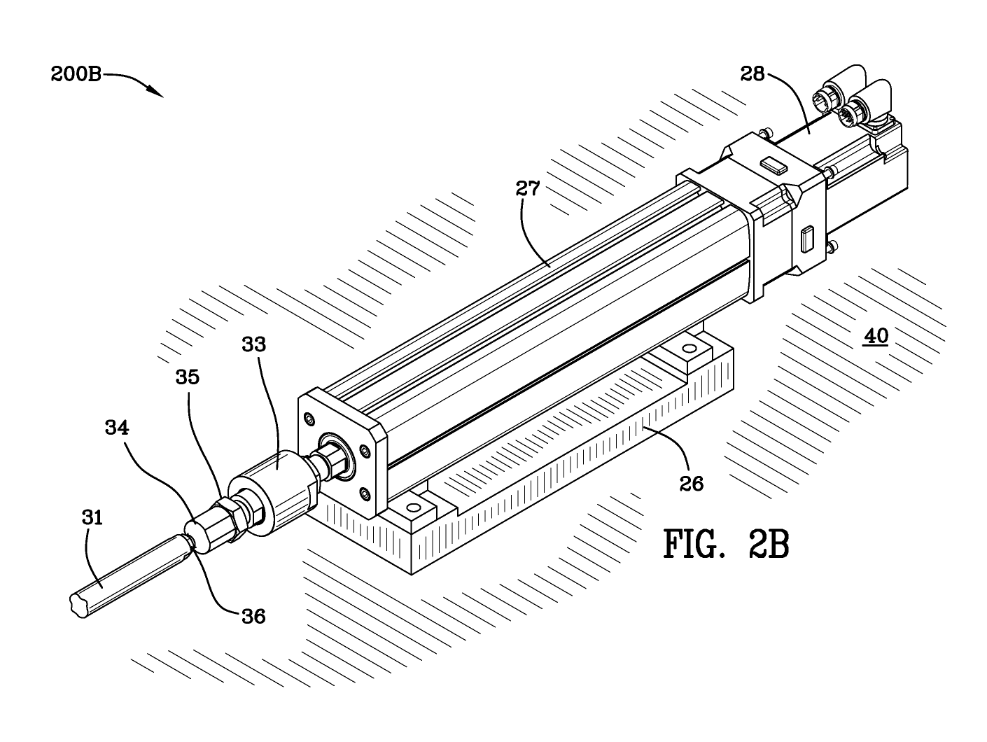

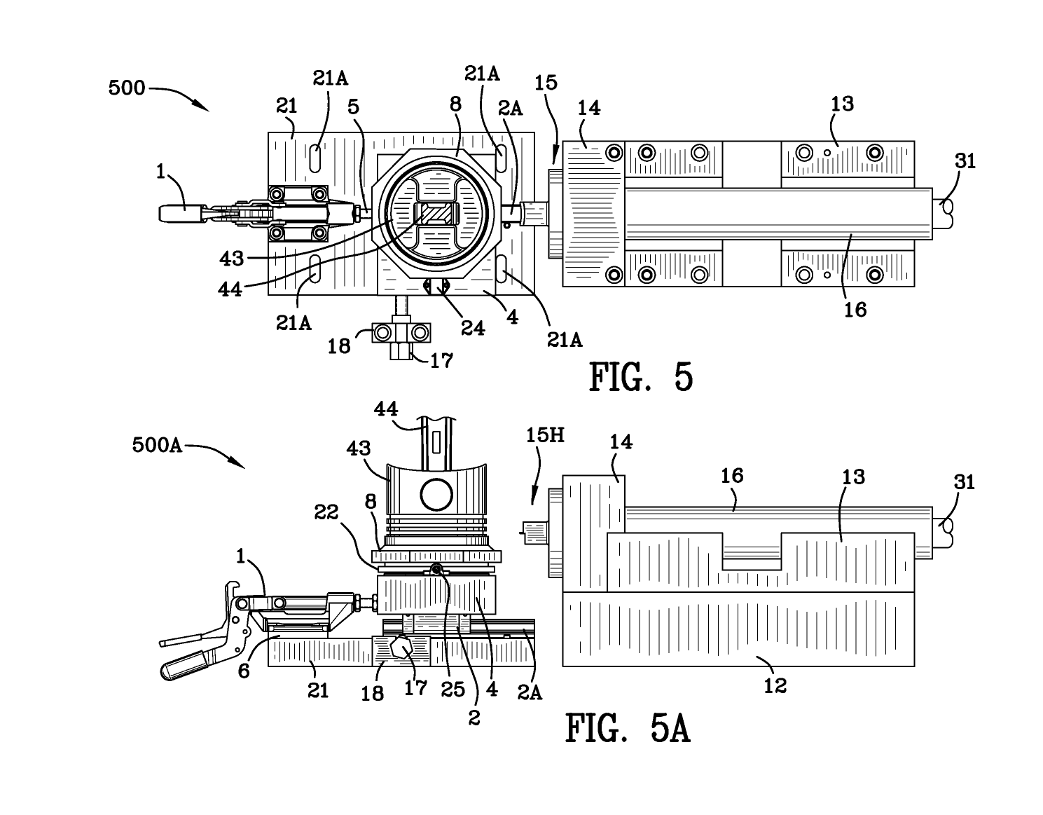

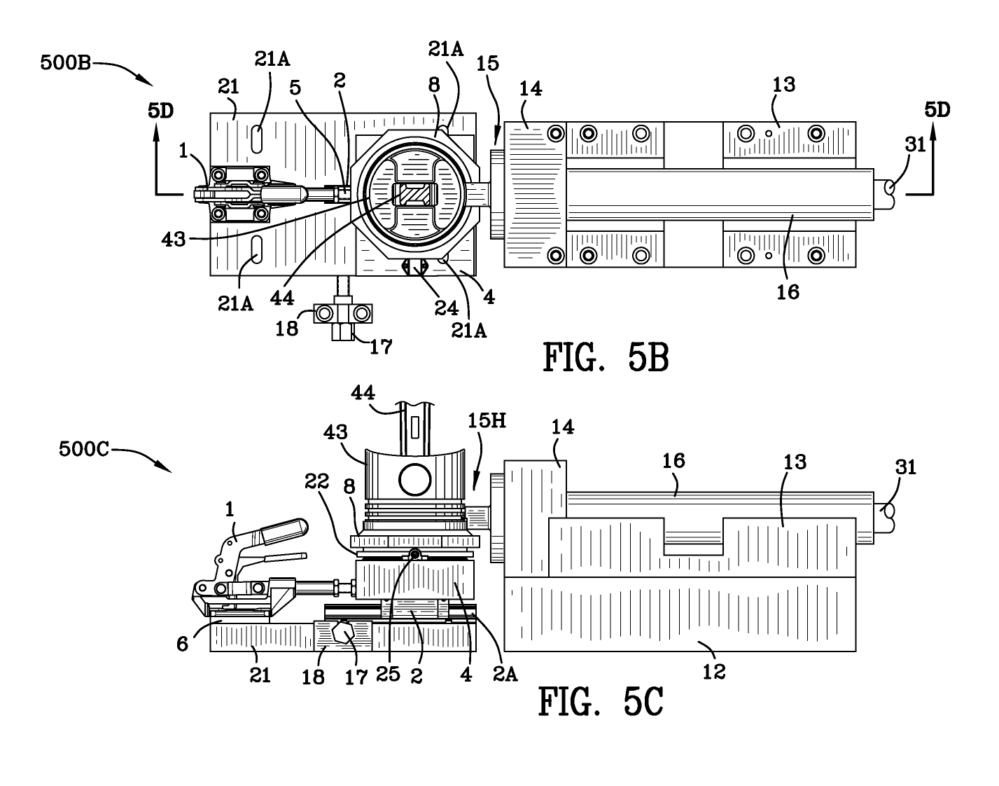

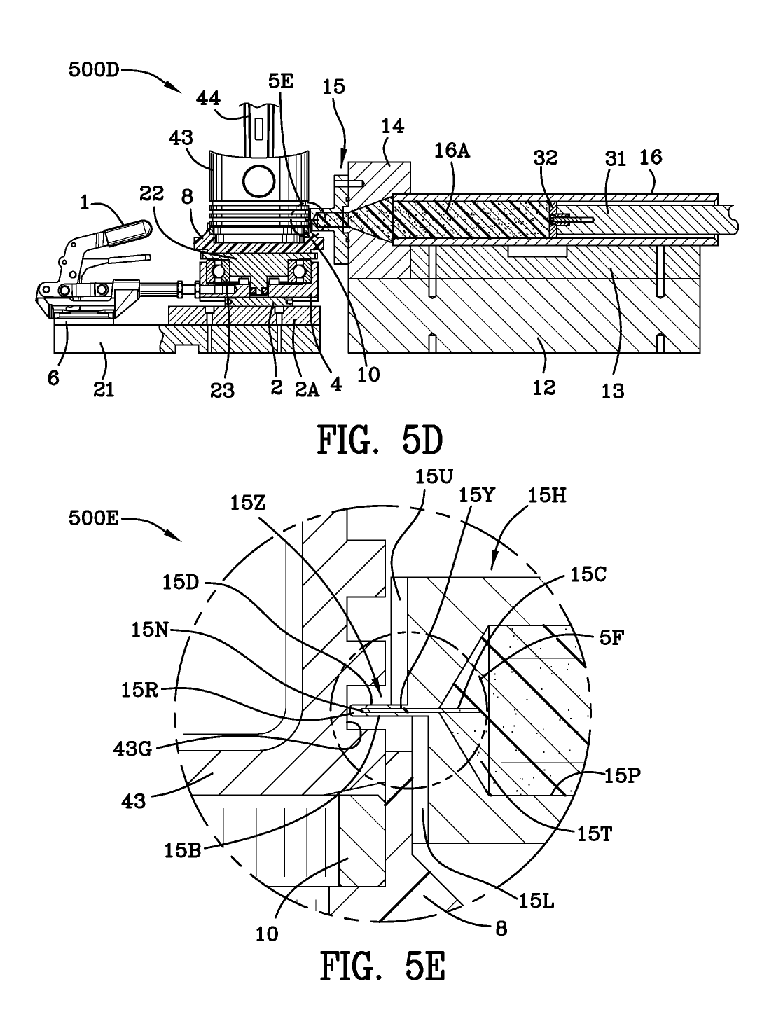

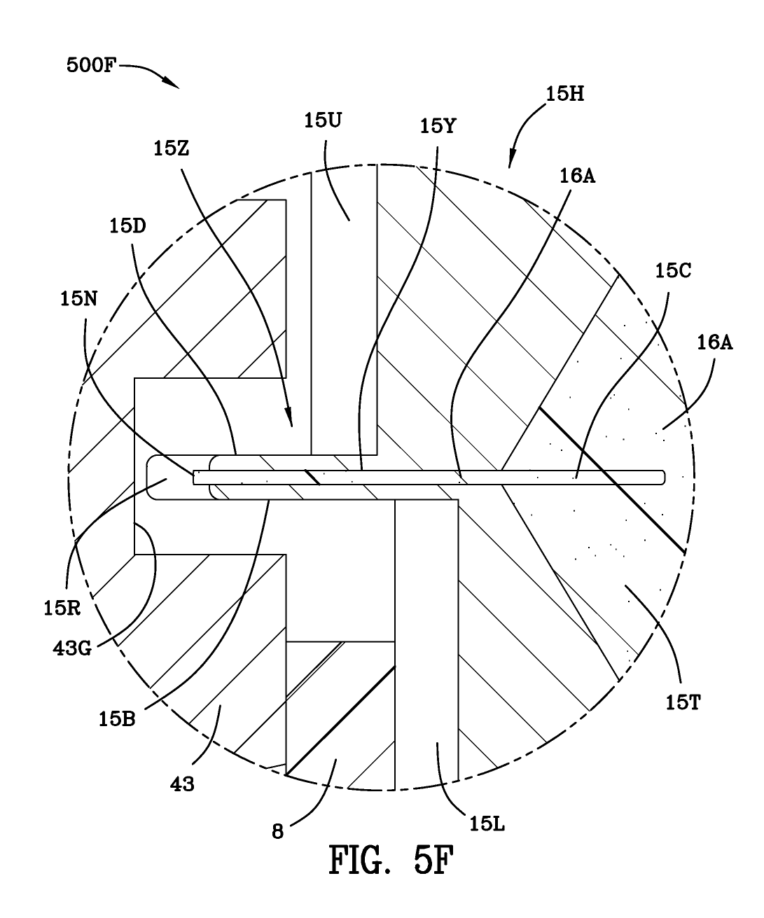

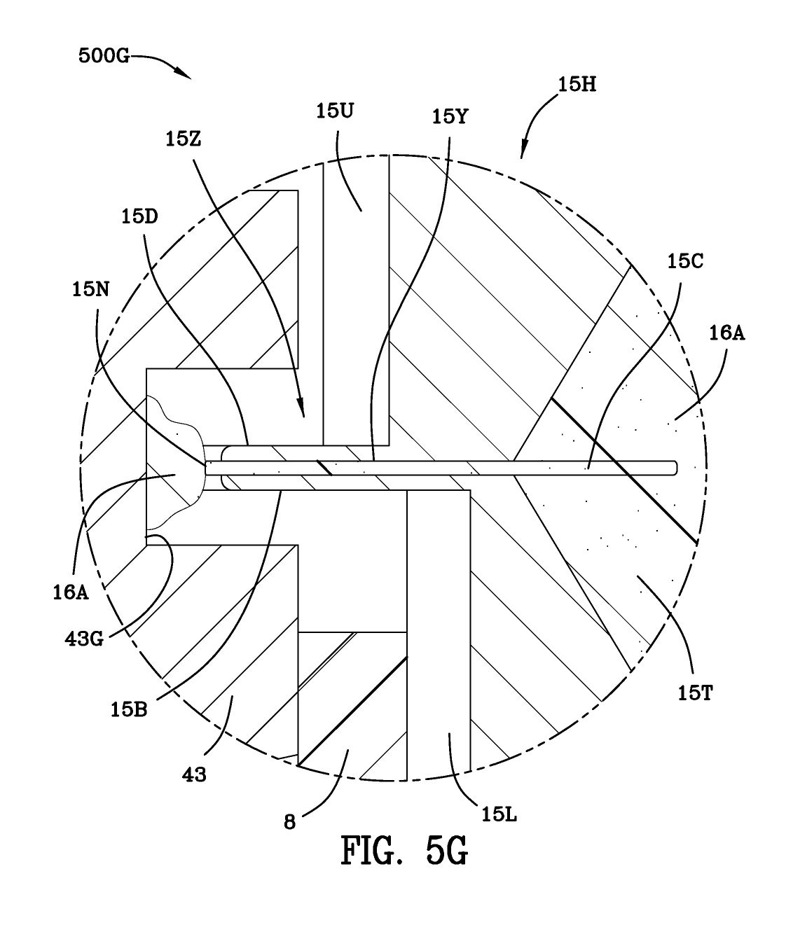

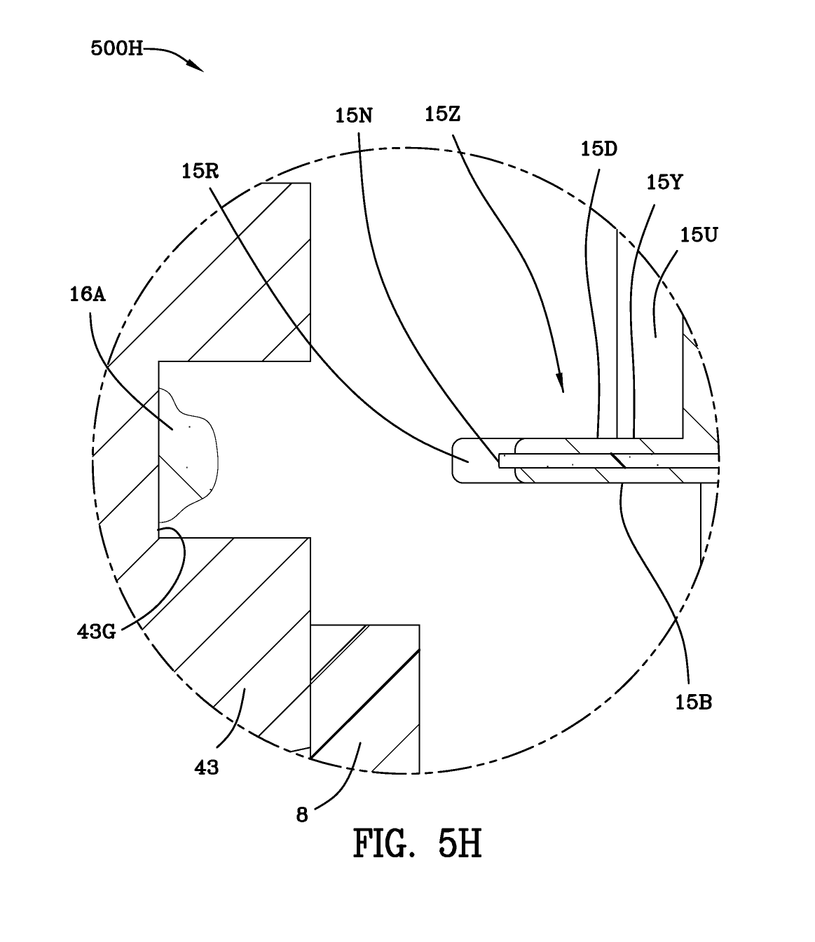

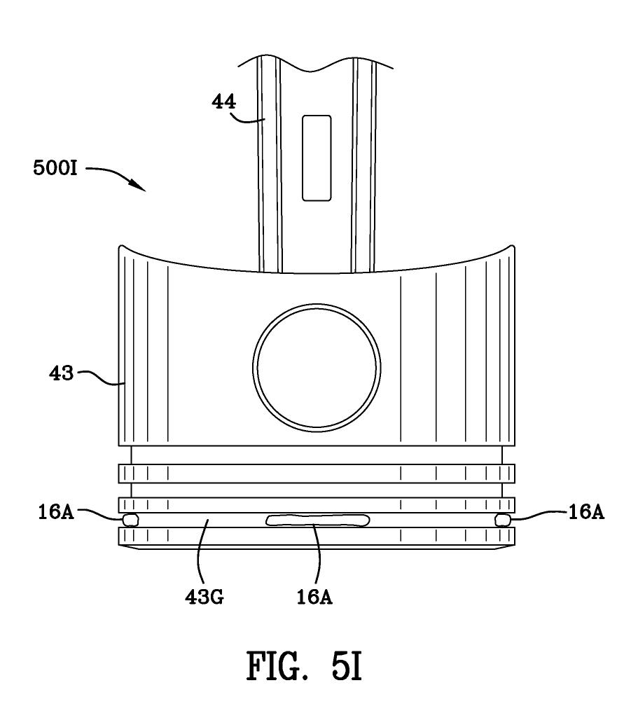

FIG. 2 is a perspective view 200 of the malleable material insertion apparatus 99. FIG. 2A is an enlarged perspective view 200A of the clamp mechanism 1, clamp spacer 6, piston nest 8, piston indexing mechanism 24, 25, malleable material nozzle 15, nozzle block 14, malleable material tube 16, plunger 37 and shaft 31. Shaft 31 moves linearly as illustrated in FIGS. 2 and 2A. Plunger 32 as illustrated in FIGS. 2 and 2A is illustrated outside of tube 16. Tube 16 contains a supply of wax or other malleable material. When the supply of wax is depleted through sustained use of the apparatus, a new tube of wax 16 is substituted for the existing tube of wax 16A by removing the plunger 32 from the tube 16 and then replacing the tube 16 with a new fully filled tube 16. Normally plunger 32 resides within tube 16 as illustrated in FIG. 5D illustrating was 16A within the tube. FIG. 2B is an enlarged perspective view 200B of the actuator 27, electric motor 28 and shaft 31.

Referring to FIGS. 1, 2, 2A and 2B, the actuator 27 has a linear output meaning that the shaft 31 of the output moves linearly driving the plunger 32 leftward each time the motor 28 is turned “on” when the operator depresses button 41. Alignment coupling 33 interconnects the shaft output of the actuator 27 with the jam nut 35, adaptor 34, jam nut 36 and shaft 31. The malleable material insertion apparatus may be mounted on a cart 39 or it may be mounted on a fixed (stationary) platform/surface 40. FIG. 1 illustrates a cylinder/actuator spacer 26 for supporting the actuator 27, a linear bushing support 29 for supporting linear bushing 30, a cartridge spacer 12 for supporting the cartridge/tube holder 13 and the malleable material tube 16, and an adjustable base/support plate 21 which supports the rail assembly including the first track 2A, the second track 2, piston nest housing 4, piston nest spacer 22 and resilient piston nest 8. Resilient piston nest 8 may be made of nylon plastics, which may typically be filled with molybdenum disulfide lubricant powder. Alternatively, resilient piston nest 8 may be made of another type of plastic or a soft metal.

The structure of the instant apparatus is made of metal unless otherwise noted. Many different types of metal may be used such as steel, stainless steel, and alloys.

Referring to FIG. 1, clamp 1 moves the resilient rotatable piston nest 8 between a first, retracted position, and a second extended position. In the first, retracted position, the resilient rotatable piston nest 8 is spaced apart from the nozzle 15. Piston nest 8 includes a substantially cylindrical inner portion which receives a piston 43. Piston nest 8 further includes an octagonal flange which enable the operator to easily grip the flange and rotate the piston nest 8, the piston nest spacer 22 and the piston 43. Piston nest spacer 22 includes a cylindrical periphery 22p and is substantially cylindrically shaped. Piston nest spacer 22 includes a spool portion which permits rotation of the piston nest spacer while providing means for securing the spacer within the piston nest housing 4. Studs 4J, 4K are affixed to the piston nest housing and reside in the spool of the piston nest spacer to maintain the spacer in the piston nest housing.

Support plate 21 is adjustably positioned with respect to surface 40 so as to align the resilient rotatable piston nest 8 and associated piston nest housing 4 and piston nest spacer 22 with respect to the nozzle 15. Slots 21A in support plate 21 enable adjustment of the plate 21 with respect to surface 40. FIGS. 2 and 2A illustrate adjustable screw 17 in mounting block 18 which is used to position plate 21 with respect to surface 40. Mounting block 18 is affixed to surface 40 and surface 40 is indicated with shading in FIGS. 2, 2A and 2B.

Referring to FIGS. 2, 2A, 5D and others, the malleable material insertion apparatus includes a tube 16 containing malleable material (preferably wax) therein. A plunger 32 resides within the tube 16 and engages the malleable material 16A therein. The plunger 32 is movable within the tube 16 and is driven by an actuator 27 and shaft 31. The electric motor 28 drives the actuator 27 which, in turn, drives and moves the shaft 31 and the plunger 32 leftward within the tube 16. Tube 16 is generally cylindrically shaped and contains wax therein. A nozzle 15 is affixed to the nozzle mounting block 14 which includes a passageway 14C therethrough for communicating the malleable material (wax) from the tube 16 to the nozzle 15. The malleable material is preferably a wax 16A. The nozzle mounting block 14 includes a shoulder 14S therein which engages the end 16E of the tube 16. Sometimes herein the tube 16 is referred to as a cartridge 16.

The nozzle 15 includes an arcuate nozzle opening 15N and a passageway 15P therein. The arcuate nozzle opening 15N is curved allowing deposition of the wax 16A in a somewhat circumferential pattern in the root or base of the circumferential groove 43G of the piston 43 as illustrated in FIG. 5E.

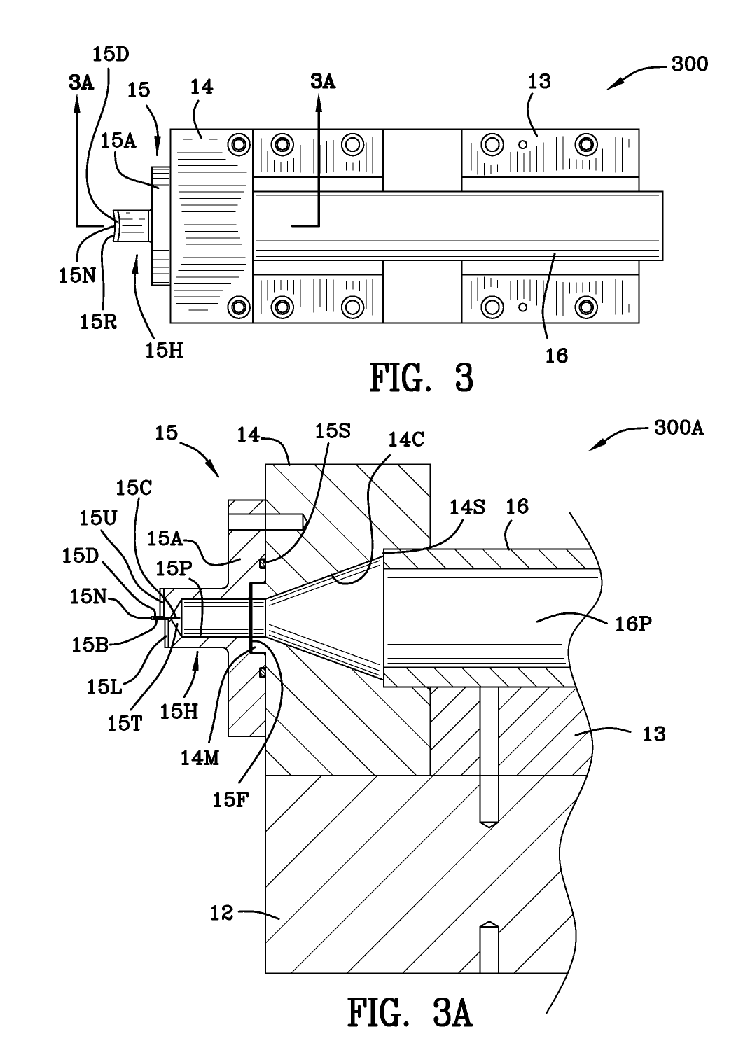

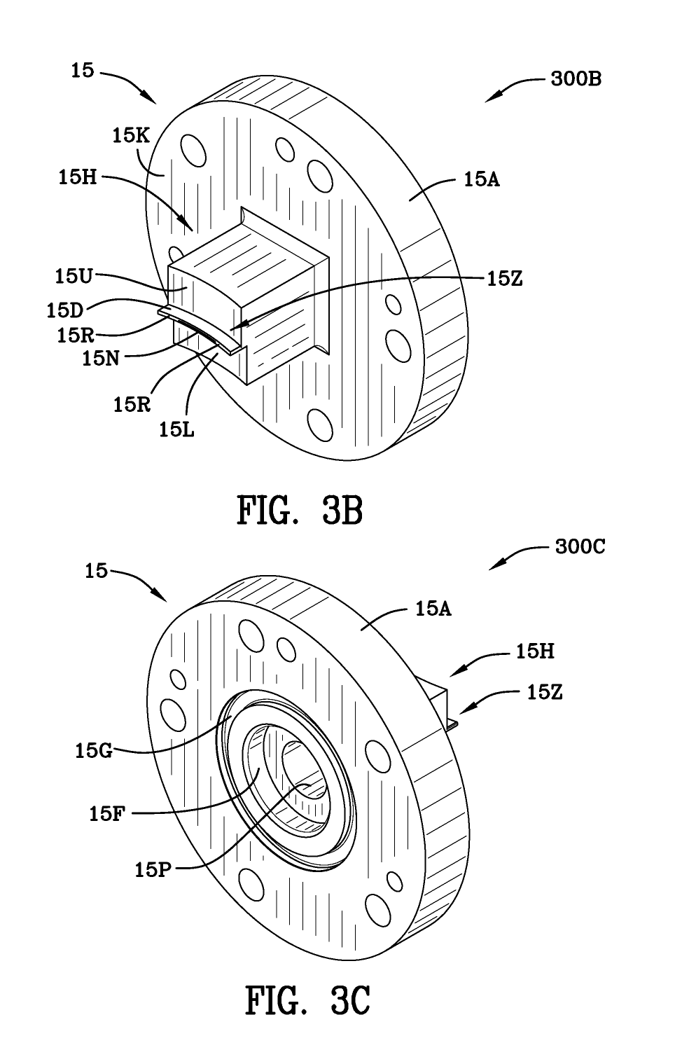

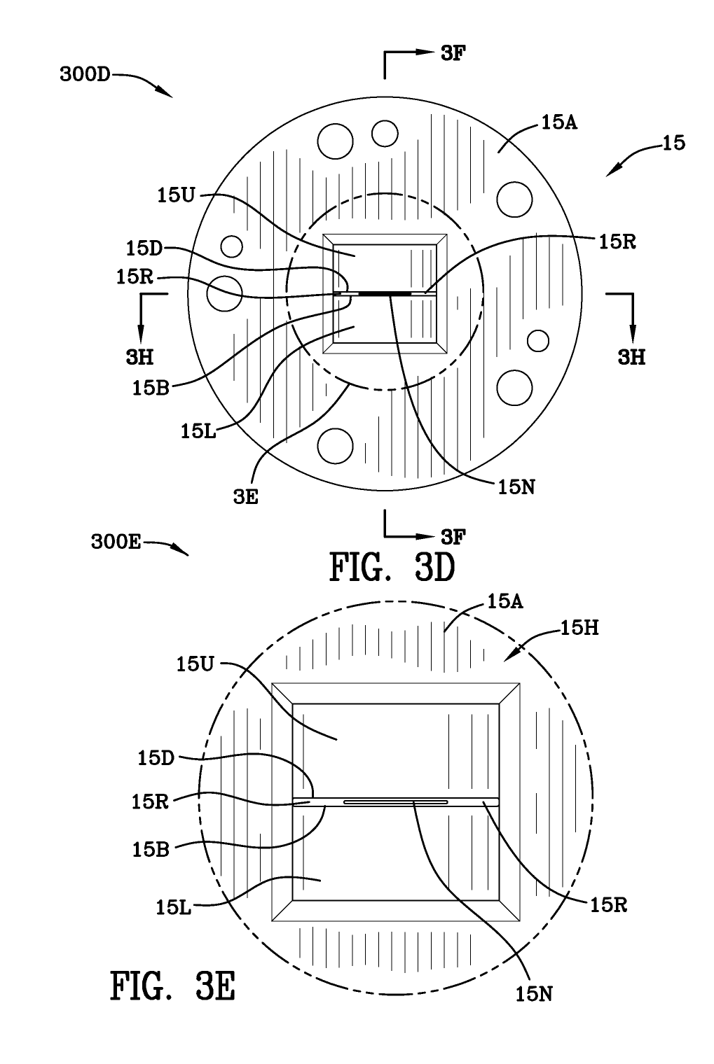

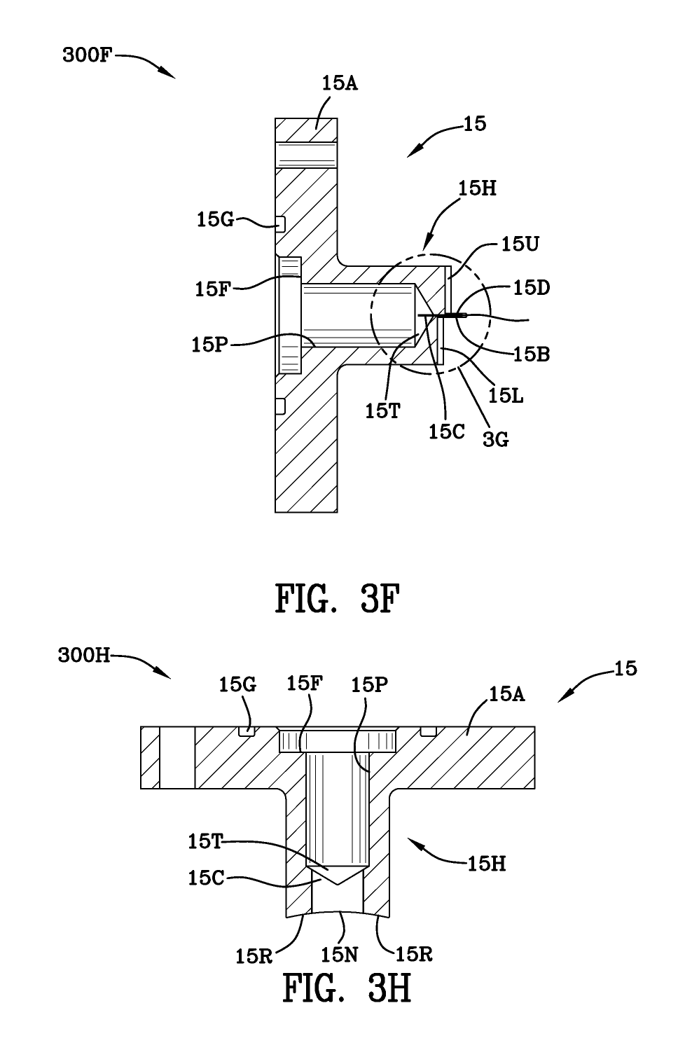

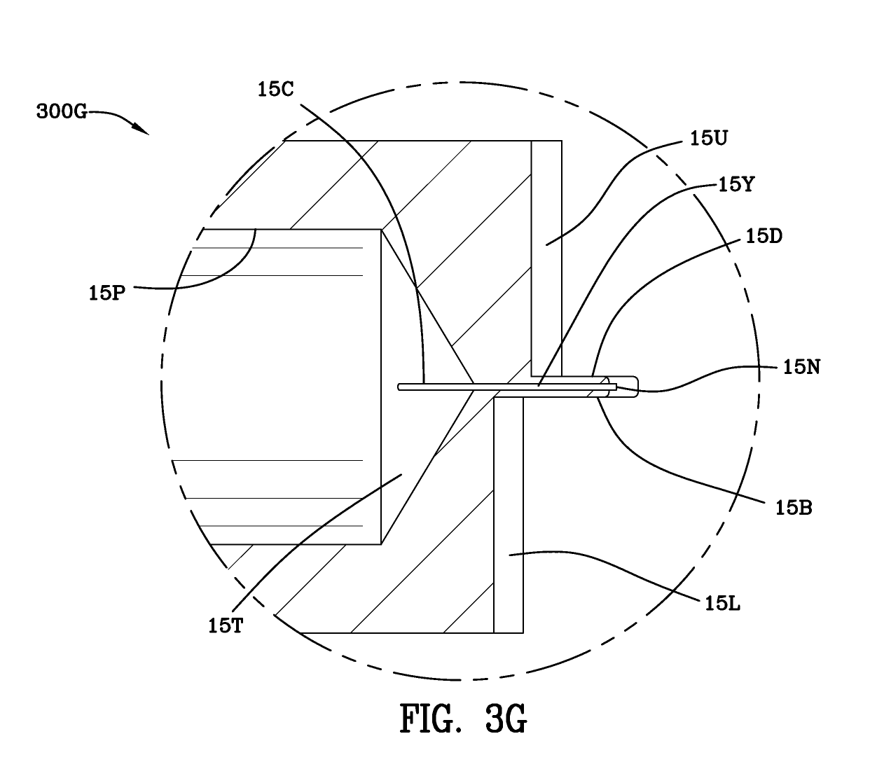

FIG. 3 is a top view 300 of the malleable material holder 13 (cartridge/tube holder), the malleable material tube/cartridge 16, nozzle block 14 and nozzle 15. Holder 13 is affixed to a spacer 12 which is attached to the surface 40 as illustrated in FIG. 2A.

FIG. 3A is a cross-sectional view 300A of the nozzle 15, nozzle block 14 and the tube 16 taken along the lines 3A-3A of FIG. 3. Arrow 15 is used to designate the nozzle generally. The nozzle includes many structural features.

FIG. 3B is a front perspective view 300B of the nozzle 15. FIG. 3C is rear perspective view 300C of the nozzle and FIG. 3D is a front view 300D of the nozzle. Base 15A of the nozzle is generally cylindrically shaped as illustrated in FIGS. 3B and 3C. Nozzle housing 15H extends outwardly from the face 15K and includes an arcuately shaped lip 15Z portion having a lower surface 15B and an upper surface 15D. FIG. 3E is an enlarged portion 300E of FIG. 3D.

Referring to FIGS. 3D and 3E (which are both front views of the nozzle 15), arcuate nozzle opening 15N is illustrated. Arrow 15Z is the arcuately shaped lip which includes arcuate sides 15R and an arcuate nozzle opening 15N formed centrally therein between the arcuate sides 15R. Arcuately shaped lip 15Z includes a lower surface 15B and an upper surface 15D. Arcuate nozzle opening 15N deposits wax in the piston ring groove 43G of piston 43 in a somewhat arcuate shape. Arcuate upper face 15U and arcuate lower face 15L of the end of nozzle housing 15H are illustrated in FIGS. 3D and 3E. Lower face 15L of the end of the nozzle is recessed as compared to the upper face 15U of the end of the nozzle housing 15H for clearance reasons as best viewed in FIG. 5F. FIG. 5F is an enlarged portion 500F of FIG. 5E illustrating the nozzle 15 in relation to the groove 43G of piston 43 and the resilient rotatable piston nest 8. Piston 43 is held snuggly within the piston nest 8 and clearance is necessary between the piston nest 8 and arcuate lower face 15L.

FIG. 3F is a cross-sectional view 300F of the nozzle taken along the lines 3F-3F of FIG. 3D. FIG. 3G is an enlargement 300G of a portion of FIG. 3F illustrating the nozzle. FIG. 3H is a cross-sectional view 300H of the nozzle taken along the lines 3H-3H of FIG. 3D.

Referring to FIGS. 3A, 3F, 3G, 3H, and 5F and others, nozzle 15 includes an interior transition portion 15T. Transition portion 15T is conically shaped from the machining process of passageway 15P in nozzle 15. Arcuate opening 15N transitions into a generally rectangularly shaped, in cross-section, passageway 15Y in housing 15H which extends in the conical transition portion 15T where cut 15C is made therein. Cut 15C is made in the conically shaped transition portion 15T.

Referring to FIGS. 3A, 3C, 3F, and 3H and others, nozzle 15 includes cylindrically shaped female socket 15F. Female socket 15F of the nozzle 15 interfits with cylindrically shaped male protrusion 14M of the nozzle block as illustrated in FIGS. 3A. and 5D. O-ring seal 15S is interposed between the nozzle 15 and the nozzle block 14 preventing leakage of wax material from the interface between the nozzle block 14 and the nozzle 15. Groove 15G in the rear portion of nozzle 15 houses O-ring 15S.

Referring to FIG. 3A, passageway 16P of tube 16, passageway 14C in the nozzle mounting block 14, and passageway 15P in the nozzle 15 are filled with malleable material (wax) 16A therein. The wax used is commercially available and is made of 70-85% petrolatum and 15-30% carnauba wax.

FIG. 5 is a top view 500 of the piston nest 8 with a piston 43 gripped within the piston nest 8 spaced apart from the malleable material insertion nozzle 15 in the first, retracted position. FIG. 5A is a side view 500A of FIG. 5. Referring to FIGS. 5 and 5A, a rotatable piston nest 8 is made of a resilient material such as a nylon plastic typically filled with molybdenum disulfide lubricant powder. Alternatively, the rotatable piston nest 8 may be made of a soft metal. The piston 43 resides in the resilient rotatable piston nest 8 and is gripped by the resilient piston nest such that the piston 43 is rotatable with the rotatable piston nest 8. A piston nest housing 4 supports the rotatable piston spacer and the rotatable piston nest 8 such that the rotatable piston nest is rotatable within the piston nest housing 4.

FIGS. 5 and 5A illustrate the piston nest assembly 8, 10 in the first, retracted position. In the first, retracted position, clamp 1 pulls the piston nest assembly 8, 10, 22, 4, along the rail assembly 2, 2A leftward, away from nozzle 15. In the first, retracted position, the piston nest spacer 22 rotatably aligns one of the notches 22A, 22B, 22C and 22D as illustrated in FIG. 4E with the indexing mechanism 24, 25. The indexing mechanism 24, 25 is best illustrated in FIG. 4C and is comprised of a spring 25S and a ball 25B which interengage the notches. FIGS. 4-4E illustrate the resilient rotatable piston nest 8 in the first, retracted position as there is no piston 43 illustrated in FIGS. 4-4E, and, therefore no reason exists to move the empty piston nest 8 along the rail assembly 2, 2A toward and into the second, extended position.

FIG. 4 is a top view 400 of the piston nest assembly 8, 10, 22, 4, straight line clamp 1 and a portion of the rail 2A in the first, retracted position. Adjustment slots 21A enable adjustable base plate/support plate 21 to be positioned such that the piston nest 8 is properly aligned with the nozzle 15. Piston nest 8 includes an unnumbered octagonal flange which is easily gripped by the hand of an operator and then rotated until the indexing mechanism 24, 25 locks the piston in place to receive the next wax 16A deposit in the piston ring groove 43G of the piston. Clamp 1 is a lockable clamp and in the position shown in FIG. 4 it is not locked and it is in the retracted position. Alternatively, a clamp may be used that is not lockable. Threaded rod 5 is interconnected with the clamp 1 and a jam nut 7 affixed to the piston nest housing 4 as illustrated in FIGS. 2, 2A and 4A. Spacer 10 is seated in piston nest 8 and is used to raise piston 43 as is illustrated in FIG. 5E. With spacer 10, the lower of two piston ring grooves may be addressed by the nozzle 15 when the piston nest 8 is positioned in its second, extended position, by the clamp 1, rail assembly 2, 2A and the piston nest housing 4. Referring to FIGS. 4 and 4C, piston indexing mechanism 24, 25 is shown wherein threaded housing 24 is secured to the piston nest housing 4 and a spring 25S biases ball 25B for interengagement with notch 22D in a cylindrical portion of the rotatable piston nest spacer. Still referring to FIG. 4, dowel pins 8D align piston nest 8 with piston nest spacer 22 and screws 8S affix the piston nest 8 to piston nest spacer 22.

FIG. 4A is a cross-sectional view 400A taken along the lines 4A-4A of FIG. 4 illustrating the piston nest assembly 8, 10, 22, 4 and rail 2A in the first, retracted position. Rotatable piston nest spacer 22 is secured to the piston nest housing by using a first 4J and a second 4K bolt as illustrated in FIG. 4A. First and second bolts 4J, 4K are threaded into the piston nest housing and reside partially in spool 4S formed at the bottom of the piston nest spacer. The generally cylindrically shaped spool 4S enables the piston nest spacer 22 to rotate while the bolts 4J, 4K prevent the piston nest spacer from moving upwardly. Bearing 23 is interposed between the piston nest housing 4 and the piston nest spacer 22 allowing the piston nest spacer 22 to rotate with respect to the piston nest housing 4. The rotatable piston nest 8 is affixed to the piston nest spacer 22 by screws which are illustrated in FIG. 4 but which are not illustrated in FIG. 4A.

Referring to FIGS. 4, 4A, and 4B, the piston nest spacer includes a cylindrical periphery. The cylindrical periphery of the piston nest spacer includes a plurality of notches 22A, 22B, 22C, 22D for controlling the position at which the wax is inserted into the piston ring groove 43G. The piston is placed tightly into the plastic piston nest. The piston can be in any rotational position when it is placed into the piston nest. The piston nest housing 4 includes a spring 25S biased ball 25B affixed thereto which engages one of the plurality of the notches of the cylindrical periphery of the piston nest spacer 22. The spring biased ball 25B engages successive ones of the plurality of the notches 22A, 22B, 22C, 22D of the cylindrical periphery of the piston nest spacer 22 as the piston nest spacer is rotated. The piston nest 8 is rotated by hand and has an octagonal flange which is easily gripped by the operator of the insertion apparatus.

A rail includes a first stationary track 2A and a second track 2 slidably engaged with the track as illustrated in FIGS. 4A and 4B. The piston nest housing 4 is affixed by screws 4L, 4M to the second track 2 of the rail and slides therewith. The first stationary track 2A is affixed to a plate 21. The plate 21 supports the clamp, the first stationary track, the second track, the piston nest housing, the piston nest spacer, and the piston nest.

FIG. 4B is a cross-sectional view 400B taken along the lines 4B-4B of FIG. 4 illustrating the piston nest assembly 4, 22, 23, 8, and the rail assembly 2, 2A, and piston nest indexing mechanism 24, 25. FIG. 4C is an enlargement 400C of a portion of FIG. 4B illustrating the piston nest indexing mechanism 24, 25. FIG. 4D is a side view 400D of the piston nest assembly 4, 22, 23, 8, rail assembly 2, 2A and clamp 1.

FIG. 4E is a cross-sectional view 400E taken along the lines 4E-4E of FIG. 4D illustrating the piston nest indexing mechanism 24, 25, the piston nest spacer 22, and the notches 22A, 22B, 22C, and 22D in the piston nest spacer 22. Notches 22A, 22B, 22C, and 22D are spaced apart by 90°. The octagonal flange of piston nest 8 is rotated after the insertion of wax in groove 43G, to the position of the next notch. FIGS. 4E and 4F illustrate the piston nest spacer 22 and its outer periphery 22P with notches 22A, 22B, 22C, and 22D therein with indexing mechanism 24, 25 illustrated engaging groove 22D. In the position of FIGS. 4A-4F, the piston nest 8 is in the first, retracted position.

FIG. 5 is a top view 500 of the piston nest 8 with a piston 43 gripped within the piston nest 8 spaced apart from the malleable material insertion nozzle 15. FIG. 5A is a side view 500A of FIG. 5. FIGS. 5 and 5A illustrate the resilient piston nest 8, the piston 43, and the piston nest housing 4 in the first, retracted position away from nozzle 15. In the position illustrated in FIGS. 5 and 5A, the piston nest 8 has been rotated such that one of the notches in the piston nest spacer is in engagement with the indexing mechanism 24, 25. FIGS. 5B and 5C illustrate the resilient piston nest 8, the piston 43, and the piston nest housing 4 in the second, extended position in proximity to the nozzle. FIG. 5B is a top view 500B of the piston nest assembly illustrating a piston 43 gripped within the piston nest 8. In FIG. 5B the piston nest 8 is spaced in proximity to the malleable material insertion nozzle 15. FIG. 5C is a side view 500C of FIG. 5B. In the position illustrated in FIGS. 5B and 5C, the piston has been placed such that the piston groove 43G is ready to receive the malleable wax from the nozzle.

FIG. 5D is a cross-sectional view 500D taken along the lines 5D-5D of FIG. 5B illustrating wax 16A within the tube 16, the nozzle block 14 and the nozzle 15 ready for deposition in the groove 43G. FIG. 5E is an enlarged portion 500E of FIG. 5D illustrating the nozzle 15 inserted in one of the piston ring grooves 43G of piston 43. FIG. 5E further illustrates, in cross-section, the arcuate nozzle opening 15N and one of the arcuate sides 15R as it curves around within the piston ring groove 43G. Arcuate upper face 15U and arcuate lower face 15L are also illustrated in FIG. 5E. Arcuate lower face 15L is recessed with respect to arcuate upper face 15U to accommodate the piston nest 8. If another piston groove above groove 43G is to receive deposits of malleable wax, then spacer 10 is removed from the piston nest 8 and then the piston will reside lower within the piston nest 8 to receive the arcuate nozzle opening 15N.

FIG. 5F is an enlarged portion 500F of FIG. 5E illustrating the nozzle 15 in relation to the groove 43G of piston 43 and the resilient rotatable piston nest 8. Piston 43 is held snuggly within the piston nest 8 and clearance is necessary between the piston nest 8 and arcuate lower face 15L as described above. FIG. 5F illustrates the same information and structure illustrated in FIG. 5E in greater detail and illustrates the passageways of the wax 16A.

FIG. 5G is an enlargement 500G similar to FIG. 5F illustrating the malleable material (preferably wax) 16A being distributed into the piston ring groove 43G of a piston 43. FIG. 5H is an enlargement 500H with the malleable material 16A in the piston ring groove 43G of a piston 43 with the nozzle 15 partially retracted. FIG. 5I is a view 500I similar to FIG. 5D with the malleable material illustrated in the tube, the nozzle block and the nozzle. FIG. 5I is a view 500I looking radially inwardly into the piston ring groove 43G of the piston 43 illustrating the arcuate deposition of the malleable material 16A into the piston ring groove 43G.

The piston nest housing 4, the rotatable piston nest 8, and the piston 43 are movable and slidable on a rail system 2, 2A. The piston nest housing 4, the rotatable piston nest 8, and the piston 43 are movable between a first, retracted position (FIGS. 5, 5A) and a second, extended position (FIGS. 5B, 5C). When the piston nest housing 4, the rotatable piston nest 8, and the piston are in the first, retracted position, the piston is spaced remotely apart from the nozzle 15 as illustrated in FIGS. 5, 5A. When the piston nest housing 4, the piston nest 8, and the piston are in the second, extended position, the piston 43 is spaced in proximity with the nozzle 15 as illustrated in FIGS. 5B, 5C. The piston 43 is spaced approximately 1.5 mm within the piston ring groove 43G when the piston nest housing 4, the piston nest 8, and the piston 43 are in the second, extended position as illustrated in FIGS. 5B, 5C.

A process for inserting a malleable material into a piston ring groove 43G of a piston, includes the steps of: loading a piston 43 having a piston ring groove 43G into a resilient rotatable piston nest 8 snugly fitting said piston 43 in said piston nest 8, said resilient rotatable piston nest 8 affixed to a rotatable piston spacer 22, said rotatable piston spacer 22 includes a first notch 22A, a second notch 22B, a third notch 22C and a fourth notch 22D; rotating said rotatable piston nest 8, said rotatable piston nest spacer 22 and said snugly fit piston until said first notch 22A of said rotatable piston nest spacer 22 engages an indexing mechanism 24, 25; moving said piston nest 8 and said piston 43 toward a nozzle 15 placing said nozzle 15N within said piston ring groove 43G of said piston 43 into said second, extended position; restraining and clamping 1 said resilient rotatable piston nest 8 and said piston 43 against movement away from said nozzle 15; injecting a malleable material 16A into a first location in said piston ring groove 43G of said piston 43; rotating said rotatable piston nest 8, said rotatable piston spacer 22 and said snugly fit piston 43 until said second notch 22B of said rotatable piston spacer 22 engages said indexing mechanism 24, 25; injecting a malleable material 16A into a second location in said piston ring groove 43G of said piston 43; rotating said rotatable piston nest 8, said rotatable piston spacer 22 and said snugly fit piston 43 until said third notch 22C of said rotatable piston spacer 22 engages said indexing mechanism 24, 25; injecting a malleable material 16A into a third location in said piston ring groove 43G of said piston 8; rotating said rotatable piston nest 8, said rotatable piston spacer 22 and said snugly fit piston 43 until said fourth notch 22D of said rotatable piston spacer 22 engages said indexing mechanism 24, 25; injecting a malleable material into a fourth location in said piston ring groove 43G of said piston 43; retracting and unclamping 1 said piston nest and said piston away from said nozzle into said first, retracted position; and, removing said piston 43 from said piston nest 8.

The step of injecting a malleable material in the piston ring groove of the piston ring includes metering the malleable material injected into the groove. The step of injecting the malleable material in the piston ring groove of the piston includes metering the wax and inserting 70 mg in the piston ring groove.

Another embodiment of the process does not depend on a specific number of notches in the rotatable piston nest spacer. There can be any number of notches in the rotatable piston nest spacer greater than or equal to 2, and there can be any corresponding number of wax deposits greater than or equal to 2 in the piston ring groove of the piston. The process for inserting a malleable material into a piston ring groove of a piston, includes the steps of: loading a piston 43 having a piston ring groove 43G into a resilient rotatable piston nest 8 snugly fitting said piston 43 in said piston nest, said resilient rotatable piston nest 8 affixed to a rotatable piston spacer 22, said rotatable piston spacer 22 includes a plurality of notches 22A-22N; rotating said rotatable piston nest 8, said rotatable piston nest spacer 22 and said snugly fit piston until said first notch 22A of said rotatable piston nest spacer 22 engages an indexing mechanism 24, 25; moving said piston nest 8 and said piston 43 from the first, retracted position toward a second, extended position, placing said nozzle within said piston ring groove 43G of said piston 43; restraining and clamping 1 said resilient rotatable piston nest and said piston against movement away from said nozzle in said second, extended position; injecting a malleable material 16A into a first location in said piston ring groove 43G of said piston 43; and, repeating said step of rotating said rotatable piston nest 8, said rotatable piston nest spacer 22 and said snugly fit piston 43 until all successive notches 22A-22N have been reached and interengaged by said indexing mechanism and said malleable material 16A has been deposited as desired in all locations in said piston ring groove 43G of said piston. The preferred malleable material is wax 16A.

### REFERENCE NUMERALS

1—straight line clamp, may or may not include a locking mechanism
2—rail sliding on stationary tongue 2A
2A—stationary tongue supporting rail 2
2C, 2D—screws affixing first stationary track 2A to supporting plate 2A
3—bearing block
4—fixture mounting plate
4J, 4K—fixture mounting plate retaining studs
4L, 4M—screws affixing the piston nest housing 4 to the movable track 2A
5—threaded rod
6—clamp spacer
7—hex jam nut
8—piston nest
8D—dowel pin for alignment of piston nest with piston nest spacer
8S—screws affixing the piston nest 8 to piston nest spacer 22
9—dowel pin
10—piston ring spacer
11—tooling plate
12—cartridge spacer interposed between the support surface 40 and the cartridge holder 13
13—malleable material cartridge holder
14—nozzle mounting block
14C—generally conically shaped passageway in nozzle block
14M—male protrusion interfitting female socket 15F
14S—shoulder in the nozzle mounting block
15—arrow indicating nozzle
15A—base of nozzle
15B—bottom of lip
15C—nozzle cut into conical transition 15T of passageway 15P
15D—top of lip 15Z
15F—female socket
15G—groove for O-ring 15S
15H—nozzle housing
15L—lower face of nozzle
15K—face of the nozzle
15N—centrally formed arcuate nozzle opening
15P—malleable material passageway in nozzle
15R—arcuate shaped sides
15S—O-ring seal
15T—conical transition of passageway 15P
15U—upper face of nozzle
15Y—rectangularly shaped portion of nozzle 15
15Z—lip of nozzle
16—tube/cartridge
16A—malleable material (wax)
16E—end of tube which engages shoulder 14S of nozzle block 14
16P—passageway in the tube/cartridge 16
17—alignment adjustment
18—adjustment block secured to support surface 40
19—O-ring
21—adjustable base plate
21A—adjustment slots in base plate 21
22—round piston nest spacer
22A, 22B, 22C, 22D . . . 22N—plurality of notches in piston nest spacer 22
22S—cylindrical spool in the bottom portion of nest spacer 22
22P—outer periphery of piston nest spacer 22
23—ball bearing supporting nest spacer 22 and nest 8
24—spring plunger base
25—spring plunger
25B—ball part of indexing mechanism
25S—spring part of indexing mechanism
26—cylinder spacer
27—actuator and gear reducer
28—high speed electric motor
29—linear bushing spacer
30—shaft-sliding linear bushings with pillow blocks
31—shaft
32—plunger
33—alignment coupling
34—adaptor
35—jam nut
36—hex jam nut
37—screw affixing plunger 32 to shaft 31
38—arrow indicating electrical control cabinet
39—frame
40—support surface
41—push button
42—pushbutton frame
43—piston
44—piston rod
100—perspective view of the malleable material insertion apparatus and control system
200—perspective view of the malleable material insertion apparatus
200A—enlarged perspective view of the clamp mechanism, piston nest, piston indexing mechanism, malleable material nozzle, nozzle block, malleable material tube, plunger and shaft
200B—enlarged perspective view of the actuator, electric motor and shaft
300—top view of the malleable material holder, malleable material tube, nozzle block and nozzle
300A—cross-sectional view of the nozzle, nozzle block and the tube taken along the lines 3A-3A of FIG. 3
300B—front perspective view of the nozzle
300C—rear perspective view of the nozzle
300D—front view of the nozzle
300E—enlarged portion of FIG. 3D
300E—cross-sectional view of the nozzle taken along the lines 3F-3F of FIG. 3D
300G—enlargement of a portion of FIG. 3F illustrating the nozzle
300H—cross-sectional view of the nozzle taken along the lines 3H-3H of FIG. 3D
400—top view of the piston nest assembly, straight line clamp and a portion of the rail.
400A—cross-sectional view taken along the lines 4A-4A of FIG. 4 illustrating the piston nest assembly and rail assembly
400B—cross-sectional view taken along the lines 4B-4B of FIG. 4 illustrating the piston nest assembly, rail assembly, and piston nest indexing mechanism
400C—enlargement of a portion of FIG. 4B illustrating the piston nest indexing mechanism.
400D—side view of the piston nest assembly, rail assembly and clamp
400E—cross-sectional view taken along the lines 4E-4E of FIG. 4D illustrating the piston nest indexing mechanism, the piston nest spacer, and the notches in the piston nest spacer
400F—enlargement of a portion of FIG. 4E illustrating the indexing mechanism engaging one of the notches in the periphery of the piston nest spacer.
500—top view of the piston nest assembly with a piston gripped within the piston nest together with the malleable material insertion nozzle
500A—side view of FIG. 5
500B—top view of the piston nest assembly with a piston gripped within the piston nest spaced in proximity to the malleable material insertion nozzle
500C—side view of FIG. 5B
500D—cross-sectional view taken along the lines 5D-5D of FIG. 5B
500E—enlarged portion of FIG. 5D illustrating the nozzle inserted in one of the piston rings
500E—enlarged portion of FIG. 5E illustrating the nozzle
500G—enlargement similar to FIG. 5F illustrating the malleable material being distributed into the piston ring groove of a piston.
500H—enlargement similar to FIG. 5F with the malleable material in the piston ring groove of a piston with the nozzle partially with drawn
500I—enlargement similar to FIG. 5D with the malleable material illustrated in the tube, the nozzle block and the nozzle

Those skilled in the art will realize that the invention has been set forth by way of examples only and that changes may be made to the invention without departing from the spirit and scope of the appended claims.

1. A malleable material insertion apparatus in combination with an automobile piston having a piston ring groove, comprising:
a tube, said tube contains a malleable material therein;
a plunger, said plunger resides within said tube and engages said malleable material therein, said plunger being movable within said tube;
an actuator;
an electric motor;
said electric motor drives said actuator;
said actuator drives and moves said plunger within said tube;
a nozzle mounting block;
a nozzle affixed to said mounting block;
said nozzle mounting block includes a passageway therein;
said nozzle mounting block includes a shoulder therein;
said tube engages said shoulder of said nozzle mounting block;
said nozzle includes an arcuate opening;
said nozzle includes a passageway in communication with said arcuate opening;
said tube, said passageway in said nozzle mounting block, and said passageway in said nozzle filled with malleable material therein; and,
said motor drives said actuator moving said plunger within said tube applying pressure to said malleable material in said tube, in said passageway in said nozzle mounting block, in said passageway in said nozzle, and in said arcuate opening causing an amount of said malleable material to be deposited in said piston ring groove.

2. A malleable material insertion apparatus in combination with an automobile piston having a piston ring groove as claimed in claim 1 wherein said malleable material is a wax.

3. A malleable material insertion apparatus in combination with an automobile piston having a piston ring groove as claimed in claim 1, further comprising a control system for metering wax from said arcuate opening.

4. A malleable material insertion apparatus in combination with an automobile piston having a piston ring groove as claimed in claim 3, further comprising:
a sensor for measuring electric current supplied to said electric motor; and,
means for discontinuing electric current to said electric motor when said electric current reaches a predetermined value.

5. A malleable material insertion apparatus in combination with an automobile piston having a piston ring groove, comprising:
a tube, said tube contains a malleable material therein;
a plunger, said plunger resides within said tube and engages said malleable material therein, said plunger being movable within said tube;
an actuator;
an electric motor;
said electric motor drives said actuator;
said actuator drives and moves said plunger within said tube;
a nozzle mounting block;
a nozzle affixed to said mounting block;
said nozzle mounting block includes a passageway therein;
said nozzle mounting block includes a shoulder therein;
said tube engages said shoulder of said nozzle mounting block;
said nozzle includes an arcuate opening;
said nozzle includes a passageway in communication with said arcuate opening;
said tube, said passageway in said nozzle mounting block, and said passageway in said nozzle filled with malleable material therein;
a rotatable piston nest;
said rotatable piston nest is made of a resilient material;
said piston resides in said resilient rotatable piston nest and is gripped by said resilient piston nest such that said piston is rotatable with said rotatable piston nest;
a rail;
a piston nest housing, said rotatable piston nest being rotatable within said piston nest housing;
said piston nest housing, said rotatable piston nest and said piston are movable and slidable on said rail;
said piston nest housing, said rotatable piston nest, and said piston are movable between a first, retracted position and a second, extended position;
when said piston nest housing, said rotatable piston nest, and said piston are in said first, retracted position, said piston is spaced remotely apart from said nozzle;
when said piston nest housing, said piston nest, and said piston are in said second, extended position, said piston is spaced in proximity with said nozzle; and,
said motor drives said actuator moving said plunger within said tube applying pressure to said malleable material in said tube, in said passageway in said nozzle mounting block, in said passageway in said nozzle, and in said arcuate opening depositing said malleable material in said piston ring groove.

6. A malleable material insertion apparatus in combination with an automobile piston having a piston ring groove as claimed in claim 5 wherein said malleable material is a wax.

7. A malleable material insertion apparatus in combination with an automobile piston having a piston ring groove as claimed in claim 5, further comprising a control system for metering wax from said arcuate opening.

8. A malleable material insertion apparatus in combination with an automobile piston having a piston ring groove as claimed in claim 7, further comprising:
a sensor for measuring electric current supplied to said electric motor; and,
means for discontinuing electric current to said electric motor when said electric current reaches a predetermined value.

9. A malleable material insertion apparatus in combination with an automobile piston having a piston ring groove as claimed in claim 5, further comprising:
a clamp affixed to said rotatable piston housing for moving said rotatable piston housing, said piston nest and said piston between said first, retracted position and said second, extended position.

10. A malleable material insertion apparatus in combination with an automobile piston having a piston ring groove as claimed in claim 5, further comprising:
a movable clamp affixed to said piston nest housing for moving said rotatable piston housing and said piston between said first, retracted position and said second, extended position.

11. A malleable material insertion apparatus in combination with an automobile piston having a piston ring groove as claimed in claim 10, wherein said clamp locks in said second position.

12. A malleable material insertion apparatus in combination with an automobile piston having a piston ring groove as claimed in claim 5, wherein said resilient rotatable piston nest is made of nylon.

13. A malleable material insertion apparatus in combination with an automobile piston having a piston ring groove as claimed in claim 5, wherein said resilient rotatable piston nest is made of plastic.

14. A malleable material insertion apparatus in combination with an automobile piston having a piston ring groove as claimed in claim 5, wherein said resilient rotatable piston nest is made of soft metal.

15. A malleable material insertion apparatus in combination with an automobile piston having a piston ring groove as claimed in claim 5, further comprising:
a piston nest spacer;
said rotatable piston nest affixed to said piston nest spacer;
a bearing permitting said piston nest spacer to rotate within said piston nest housing;
a first bolt and a second bolt retaining said piston nest spacer with respect to said piston nest housing;
said rail includes a first stationary track and a second track slidably engaged with said track; and,
said piston nest housing affixed to said second track of said rail.

16. A malleable material insertion apparatus in combination with an automobile piston having a piston ring groove as claimed in claim 5, further comprising:
a piston nest spacer;
said rotatable piston nest affixed to said piston nest spacer;
said piston nest spacer includes a cylindrical periphery, said cylindrical periphery of said piston nest spacer includes a plurality of notches;
said piston nest housing includes a spring biased plunger affixed thereto; and,
said spring biased plunger engages one of said plurality of said notches of said cylindrical periphery of said piston nest spacer.

17. A malleable material insertion apparatus in combination with an automobile piston having a piston ring groove as claimed in claim 5, further comprising:
said spring biased plunger engages successive ones of said plurality of said notches of said cylindrical periphery of said piston nest spacer.

18. A malleable material insertion apparatus in combination with an automobile piston having a piston ring groove as claimed in claim 5, wherein:
said piston is spaced approximately 1.5 mm within said piston ring groove when said piston nest housing, said piston nest, and said piston are in said second, extended position.

19. A process for inserting a malleable material into a piston ring groove of a piston, comprising the steps of:
loading a piston having a piston ring groove into a resilient rotatable piston nest snugly fitting said piston in said piston nest, said resilient rotatable piston nest affixed to a rotatable piston spacer, said rotatable piston spacer includes a first notch, a second notch, a third notch and a fourth notch;
rotating said rotatable piston nest, said rotatable piston nest spacer and said snugly fit piston until said first notch of said rotatable piston nest spacer engages an indexing mechanism;
moving said piston nest and said piston toward a nozzle placing said nozzle within said piston ring groove of said piston;
restraining and clamping said resilient rotatable piston nest and said piston against movement away from said nozzle;
injecting a malleable material into a first location in said piston ring groove of said piston;
rotating said rotatable piston nest, said rotatable piston spacer and said snugly fit piston until said second notch of said rotatable piston spacer engages said indexing mechanism;
injecting a malleable material into a second location in said piston ring groove of said piston;
rotating said rotatable piston nest, said rotatable piston spacer and said snugly fit piston until said third notch of said rotatable piston spacer engages said indexing mechanism;
injecting a malleable material into a third location in said piston ring groove of said piston;
rotating said rotatable piston nest, said rotatable piston spacer and said snugly fit piston until said fourth notch of said rotatable piston spacer engages said indexing mechanism;
injecting a malleable material into a fourth location in said piston ring groove of said piston;
retracting and unclamping said piston nest and said piston away from said nozzle; and,
removing said piston from said piston nest.

20. A process for inserting a malleable material into a piston ring groove of a piston as claimed in claim 19, wherein:
said first, second, third and fourth notches are spaced apart by 90°.

21. A process for inserting a malleable material into a piston ring groove of a piston as claimed in claim 19, wherein:
said steps of injecting a malleable material in said piston ring groove of said piston includes metering said malleable material.

22. A process for inserting a malleable material into a piston ring groove as claimed in claim 19, wherein: said malleable material is a wax.

23. A process for inserting a malleable material into a piston ring groove as claimed in claim 20, wherein: said malleable material is a plastic.

24. A process for inserting a malleable material into a piston ring groove as claimed in claim 19, wherein: said malleable material is wax and wherein said steps of injecting said malleable material in said piston ring groove of said piston includes metering said wax and inserting 70 mg of wax therein.

25. A process for inserting a malleable material into a piston ring groove of a piston, comprising the steps of:
loading a piston having a piston ring groove into a resilient rotatable piston nest snugly fitting said piston in said piston nest, said resilient rotatable piston nest affixed to a rotatable piston spacer, said rotatable piston spacer includes a plurality of notches;
rotating said rotatable piston nest, said rotatable piston nest spacer and said snugly fit piston until said first notch of said rotatable piston nest spacer engages an indexing mechanism;
moving said piston nest and said piston toward a nozzle placing said nozzle within said piston ring groove of said piston;
restraining and clamping said resilient rotatable piston nest and said piston against movement away from said nozzle;
injecting a malleable material into a first location in said piston ring groove of said piston; and,
repeating said step of rotating said rotatable piston nest, said rotatable piston nest spacer and said snugly fit piston until all successive notches have been reached and interengaged by said indexing mechanism and said malleable material has been deposited in all locations in said piston ring groove of said piston.

26. A process for inserting a malleable material into a piston ring groove of a piston as claimed in claim 25 wherein said malleable material is wax.
